(19) United States
(12) Patent Application Publication
(10) Pub. No.: US 2024/0390849 A1
(43) Pub. Date: Nov. 28, 2024

(54) SYSTEM AND METHOD FOR GAS MITIGATION

(71) Applicant: KNUCO 1, LLC, WEATHERFORD, TX (US)

(72) Inventors: David John Bower, Alice, TX (US); Michael Henry Parker, Weatherford, TX (US)

(73) Assignee: KNUCO 1, LLC, WEATHERFORD, TX (US)

(21) Appl. No.: 18/679,861

(22) Filed: May 31, 2024

Related U.S. Application Data
(63) Continuation-in-part of application No. 18/323,962, filed on May 25, 2023.
(60) Provisional application No. 63/505,803, filed on Jun. 2, 2023.

(51) Int. Cl. B01D 53/80; B01D 53/62

(52) U.S. Cl. CPC B01D 53/80; B01D 53/62; B01D 2251/404; B01D 2251/602; B01D 2257/504; B01D 2258/06

(57) ABSTRACT

Increasing the pressure of a slurry by a filter press in which mineral oxide reacts with carbon dioxide enhances the formation of the carbonate by increasing the solubility and availability of carbon dioxide, accelerating reaction rates, shifting equilibria favorably, and promoting the formation of reaction intermediates like bicarbonate ions. A more efficient and faster synthesis of metal carbonates results.

### RELATED APPLICATION

The present Application is a continuation in part of, and claims priority to, U.S. patent application Ser. No. 18/323,962 filed May 25, 2023, and further claims the benefit of priority to U.S. Provisional Patent Application No. 63/505,803 filed Jun. 2, 2023, which are both hereby incorporated by reference in their entirety for all purposes as if fully set forth herein.

### BACKGROUND OF THE INVENTION

### Field of the Invention

Embodiments of the present invention relate, in general, to migrant gas capture and sequestration and more particularly to a slurry based migrant gas capture and sequestration system.

### Relevant Background

It is generally recognized that global warming is caused by the accumulation of greenhouse gases in the atmosphere. In 2015 COP21, also known as the 2015 Paris Climate Conference, proposed an agreement to keep the global average temperature rise below 2° C. above preindustrial levels by limiting total carbon emissions in the atmosphere. One key option to reduce CO2 and similar greenhouse gas emissions and finally to meet the aforementioned goal is employing carbon capture and storage technologies. Carbon Capture and Sequestration (CCS) is one of the main methods used for greenhouse gas sequestration. CCS is the process of capturing greenhouse gases that would otherwise be released into the atmosphere and instead storing it underground. This involves capturing the greenhouse gas at the source and transporting it to a storage site, typically an underground storage facility. CCS technologies are considered to offer the greatest potential for greenhouse gas mitigation from the use of fossil fuels such as in coal- and gas-fired power plants and other industrial sites.

Geological storage of greenhouse gases is widely accepted as the most viable option for large-scale storage and can be accomplished by a variety of means. In one instance, CO2 or similar gases can be injected into saline aquifers, oil and gas reservoirs, or deep coal beds. The injected gas then can be trapped under the ground via a sequence of trapping mechanisms such as stratigraphic, residual, solubility, and mineral trapping. The most attractive approach is transforming these gases ex situ into mineral carbonates. Because mineral carbonates such as CaCO3 or MgCO3 are the thermodynamically most stable form of carbon, long-term storage of CO2e can be achieved once it is transformed to carbonates.

CCS technologies aim at mitigating greenhouse gas emissions by capturing greenhouse gases from large point sources, such as fossil fuel power plants and industrial facilities including cement, iron, and steel, chemical and refining facilities, transporting the carbon to storage sites, and finally storing or sequestering it in geological formations. Capture of atmospheric carbon associated with mixed flue gases typically utilizes a chemical solution as the capture media or a dry solid utilized as an absorbent which leads to generate another process step for removal of the carbon prior to sequestration. This process is generally referred to as mineral carbonation.

Ex-situ mineral carbonation carries out a series of chemical processes above ground via reactions between CO2 and the like and alkaline earth metals such as calcium or magnesium that are extracted from naturally occurring silicate minerals, i.e., wollastonite, olivine, serpentine, etc., or industrial by-products or waste materials, i.e., coal fly ash, steel and stainless-steel slags, and cement and lime kiln dusts. The result is a carbon-based compound that can be sequestered. Because this ex-situ mineral carbonation involves energy-intensive processes during the preparation of the solid reactants, including mining, transport, grinding and/or activation, as well as the recycling of additives and catalysts, the process is costly. Despite this shortcoming, ex-situ mineral carbonation also has unique advantages. As opposed to in-situ methods, this technique allows the utilization of alkaline-metal feedstock extracted from industrial wastes, which are generally recognized to have environmentally hazardous effects, and in this light furnish an appropriate method for proper disposal or for recycling is a significant environmental issue. More importantly, the final products, such as Calcium Carbonate (CaCO3), can be converted to value-added materials that can be utilized in various applications such as adhesives, sealants, food and pharmaceuticals, paints, coatings, paper, cements, and construction materials.

Precipitated CaCO3 has many industrial applications depending on its physicochemical characteristics such as particle size, shape, density, color, brightness, and other properties, and it is also known that those characteristics are significantly governed by the polymorphs of CaCO3. The precipitated CaCO3 has three polymorphs, such as calcite, aragonite, and vaterite. It has been reported that the formation behavior of each polymorph is affected by synthesis factors including pH, temperature, concentration, and ratio of carbonate and calcium ions, additives, stirring, reaction time, etc.

The transformation of carbon from CO2 into its CaCO3 or MgCO3 form is not without its challenges. Reactants necessary to enable this formation are expensive and difficult to easily obtain. Moreover, current methodologies of CCS employ an energy-intensive process. This leads to industry reluctance to embrace greenhouse gas mitigation, ultimately failing to meet Paris Climate Conference goals, yet the need to sequester carbon based emissions continues to grow as more countries and companies recognize the need to reduce their carbon footprints. A need therefore exists to capture and sequester greenhouse gases effectively and efficiently, forming a precipitate such as CaCO3 having additional and beneficial uses.

This need is compounded with the fact that in mining, agriculture, and some hydrocarbon consumptive industries such as coal fired power stations tailings or refuse ponds are used to process water, store waste, or discharge fine sized range unwanted materials. Tailing ponds of this nature are problematic for a multitude of safety and environmental reasons, despite the natural off gassing of anthropogenic emissions.

Materials in suspension in these tailing ponds contribute to the increasing presence of greenhouse gases which are targeted for reduction under the Kyoto Protocols and Paris agreements. Dewatering the contents and recovery of the materials stored in these types of ponds would contribute at once to the targets for reduction of carbon emissions by reducing the stored substance's ability to become oxidized and thereby emit.

An additional need exists to eliminate carbon-based gases off gassing through dewatering, recovery, and proper storage of fine and waste tailings and the like. Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

A gas is injected/dissolved/infused/aspirated into a slurry including one or more sequestered materials such as a mineral oxide. The combined gasified slurry is directed to a pressure inducing device such as a filter press creating a mineralization environment in which a carbonate precipitate is formed. The slurry is thereafter dewatered, stabilizing the carbonate principate and sequestering carbon including carbon dioxide equivalents.

In another embodiment, a slurry containing CO2 in solution passes through a venturi at high velocity. As the slurry passes through the venturi, pressure within the venturi drops enabling the introduction of reactive gases to the slurry. Cavitation occurs when the pressure drops below the vapor pressure of the liquid, causing the formation of vapor bubbles. These bubbles collapse, releasing energy in the form of shock waves helping mix the slurry with the additive gases and increase a chemical reaction rate. The lowered pressure and venturi configuration induces cavitation and turbulent flow.

In one version of the present invention, atmospheric gas is introduced to a mixing chamber acting as a catalyst with ionic inversions. The gas creates a more uniform distribution of ions in the slurry, allowing for better reaction rates while reducing surface tension of the slurry, allowing for better mixing. The combination of cavitation, turbulent flow, and the addition of atmospheric gas creates an efficient reaction process forming a carbon rich precipitate.

In one embodiment of the present invention, particulates typically destined for discharge or dewatering from an industrial process are pumped as a slurry from a collection vessel through a solids-handling venturi. Such industrial processes include as wash water from a concrete plant, silica sand plant, coal fired power station or waste recycling system. In other embodiments an array of venturis is utilized depending on the rate of particulate discharge. Depending on physical parameters of the particulate solid in the slurry the flow velocity or flow rate is controlled to generate a pressure drop across the venturi sufficient to cause the aspiration of gases into the slurry and create energy required to mix the specific gases into the slurry flow.

The venturi or venturi array motivates a pressure drop due to the slurry velocity increasing as it passes through the venturi throat or neck. Atmospheric air within a mixing chamber or zone of diminished pressure is drawn into the flow whereupon the atmospheric air and slurry flow combine through high turbulence and cavitation energy release within the mixing chamber of the venturi. Upon ejection from the venturi, an exit diffuser reduces turbulence reestablishing laminar flow to allow for transport to a vessel, clarifier, or dewatering device etc.

Post-venturi, the slurry is dewatered, compressed, and collected using a device such as a membrane filter press, resulting in a mineral precipitate rich residual. Any gases captured in the recovered water are cycled back to the start of the process for reintegration into the slurry.

A system for migrant gas capture and sequestration, according to another embodiment of the present invention includes a convergent/divergent apparatus comprised of a conical convergent section, a cylindrical throat, and a conical outlet. A slurry flow, that includes a sequestered material, is directed through the convergent/divergent apparatus at a flow rate. An inlet, the inlet having a pressure valve or similar means, is configured to inject a gas into and interact with the slurry flow. Lastly the system includes a mixing chamber fluidically coupled to the conical outlet and downflow of the inlet enabling the slurry flow to combine with the gas to form a cavitating turbulent flow. This cavitating turbulent flow forms a precipitate within a post conical outlet.

Other features of the above-described systems include:
wherein the gas is air.
wherein the precipitate is a carbonate.
wherein the precipitate is Calcium Carbonate (CaCO3)
wherein the precipitate is Magnesium Carbonate (MgCO3)
wherein the precipitate is Iron Carbonate (FeCO3)
wherein the precipitate is dolomite (CaMgCO3
wherein the precipitate is a crystalline carbonate.
wherein the filter press is a membrane filter press.
wherein the gas is selected from the group consisting of CO2, CH4, N2O, Halogens, PFC, Sf6 NF3 and HFC.
a convergent/divergent apparatus and wherein the convergent/divergent apparatus includes an inlet.
wherein the gas is selected from the group consisting of Hydride, H-, K, Na, Ba, Mg, NaH, LiH, LiAJH, CaH2, Ak.
a mixing chamber downflow of the inlet forming a cavitating turbulent flow.
wherein the one or more sequestered materials includes one or more oxide components.
wherein the one or more oxide components are selected from the group consisting of CaO, MgO, and FeO.
a stabilized precipitate formed in response to dewatering the precipitate.

A method for gaseous mitigation, according to one embodiment, begins with identifying a slurry flow in which the slurry flow includes one or more sequestered materials. Gas is injected into the slurry flow forming a gasified slurry flow. Thereafter the gasified slurry flow is pressurized triggering the formation of a precipitate which is then dewatered leaving behind a stabilized precipitate.

Other features of the process described above may include:
wherein the gas is air.
wherein injecting includes controlling an amount of the gas injected thereby controlling alkalinity of the gasified slurry flow.
wherein the precipitate is a carbonate.
wherein the precipitate is Calcium Carbonate (CaCO3).
wherein the precipitate is Magnesium Carbonate (MgCO3).
wherein the precipitate is Iron Carbonate (FeCO3).
wherein the precipitate is dolomite (CaMgCO3.
wherein the precipitate is a crystalline carbonate.
wherein the precipitate is a crystalline, a polymorph, or amorphous.
wherein the filter press is a membrane filter press.
heating the gasified slurry flow thereby enhancing the mineralization environment.
wherein the gas is selected from the group consisting of CO2, CH4, N2O, Halogens, PFC, Sf6 NF3 and HFC.
wherein the gas is selected from the group consisting of Hydride, H-, K, Na, Ba, Mg, NaH, LiH, LiAJH, CaH2, Ak.
inducing turbulent flow within the filter press.
directing a slurry flow through a convergent/divergent apparatus and wherein the convergent/divergent apparatus includes an inlet.
forming a cavitating turbulent flow in a mixing chamber downflow of the inlet, thereby combining the slurry flow with the gas.
wherein the one or more sequestered materials includes one or more oxidizing components.
wherein the one or more oxide components are selected from the group consisting of CaO, MgO, and FeO.

In yet another embodiment of the present invention, a process for making a product begins by directing a slurry flow through a convergent/divergent apparatus at a flow rate. In this instance, the slurry flow includes a sequestered material. Moreover, the convergent/divergent apparatus includes a conical convergent section, a cylindrical throat, and a conical outlet. The process continues by injecting a gas into an inlet at an inlet location on the convergent/divergent apparatus. The inlet includes a pressure valve thereby interacting with the slurry flow responsive to the pressure value reaching a predetermined value.

The process then forms a cavitating turbulent flow in a mixing chamber within the conical outlet, downflow of the inlet, thereby combining the slurry flow with the gas. Lasty the process concludes by precipitating a precipitate within the mixing chamber of the conical outlet in a post conical divergent outlet slurry flow.

Other features of the process described above may include:
wherein the slurry flow is incompressible.
wherein the sequestered material includes carbon dioxide equivalents.
wherein the gas is air.
wherein injecting includes controlling a volume of the gas injected thereby controlling acidity of the gasified slurry flow.
controlling an amount of the gas injected into the inlet thereby controlling a decrease in alkalinity of the slurry flow by the cavitating turbulent flow in the mixing chamber.
wherein the precipitate is calcium carbonate.
wherein the precipitate is a precipitate is a crystalline, a polymorph or an amorphous.
directing a filter configured to remove the precipitate from the post conical divergent outlet slurry flow.
wherein the filter is a membrane filter.
removing the precipitate from the post conical divergent outlet slurry flow.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The features and objects of the present invention, among other things, and the manner of attaining them will become more apparent, and the invention itself will be best understood, by reference to the following description of one or more embodiments taken in conjunction with the accompanying drawings, wherein:

FIG. 1 is a representative venturi configuration as would be employed in one or more embodiments of the present invention.

FIG. 2 is a graphical image of cavitated turbulent flow in the divergent section of a venturi as would be employed in one embodiment of the present invention.

FIG. 3 provides a high-level view of a system to accelerate the sequestration or confinement of mixed gases with solid particulates, according to one embodiment of the present invention.

FIG. 4 is an expanded cross-sectional view of a nozzle configuration for slurry based migrant gas sequestration, according to one embodiment of the present invention.

FIG. 5 is an expanding cross-sectional view of mixing chamber configuration for slurry based migrant gas sequestration, according to one embodiment of the present invention.

FIG. 6 presents a view of a convergent nozzle in concert with a mixing chamber for slurry based migrant gas sequestration, according to one embodiment of the present invention.

FIG. 7 illustrates a flow/system diagram of the capture, mixing and delivery process by which atmospheric and/or anthropogenic carbon dioxide is secured for sequestration, according to one embodiment of the present invention.

FIG. 8 illustrates a closed flow/system diagram of the capture, mixing and delivery process by which atmospheric and/or anthropogenic carbon dioxide is captured from an industrial activity and thereafter secured for sequestration, according to one embodiment of the present invention.

FIG. 9 provides a flowchart of one methodology for slurry based migrant gas sequestration, according to one embodiment of the present invention.

FIG. 10 is a high-level system diagram of one embodiment for a system for creating a mineralization environment for sequestration of migrant gases.

FIG. 11 provides a flowchart of another methodology for slurry based migrant gas sequestration, according to one embodiment of the present invention.

The Figures depict embodiments of the present invention for purposes of illustration only. Like numbers refer to like elements throughout. In the figures, the sizes of certain lines, layers, components, elements, or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

A mineralization environment is created by which migrant gases such as CO2 and CH4 in solution of a slurry join with receptive minerals forming carbon-based precipitates. By use of a membrane filter press, the precipitate is dewatered thereby stabilizing a carbonate which can be safely stored. Chemical and gas modifications to the slurry are accomplished to enhance the mineralization process.

In another version of the present invention a mineralized slurry containing CO2 in solution passes through a venturi at high velocity. As the slurry passes through the venturi, pressure within the venturi drops enabling the introduction and mixing of reactive gases into the slurry. Pressure thereafter increases, causing cavitation and turbulent flow releasing energy in the venturi's divergent section. As the atmospheric gas introduced to a mixing chamber is joined with energy of cavitation and turbulent flow it acts as a catalyst creating ionic inversions. The gas forms a uniform distribution of ions in the slurry, allowing for reaction rates to increase while reducing surface tension of the slurry, thereby allowing better mixing. The combination of cavitation, turbulent flow, and the addition of atmospheric gas creates an efficient reaction process forming carbon-based precipitates.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein any reference to “Carbon Dioxide (CO2) equivalent, abbreviated as CO2-eq or CO2e, means a metric measure used to compare the emissions from various greenhouse gases based on their global-warming potential (GWP), by converting amounts of other gases to the equivalent amount of carbon dioxide with the same global warming potential. Carbon dioxide equivalents are commonly expressed as million metric tonnes of carbon dioxide equivalents, abbreviated as MMTCDE.

The carbon dioxide equivalent for a gas is derived by multiplying the tonnes of the gas by the associated GWP: MMTCDE=(million metric tonnes of a gas)*(GWP of the gas). For example, the GWP for methane is 25 and for nitrous oxide 298. This means that emissions of 1 million metric tonnes of methane and nitrous oxide respectively is equivalent to emissions of 25 and 298 million metric tonnes of carbon dioxide.

Greenhouse gases (GHGs) are understood to mean the gases in the atmosphere that raise the surface temperature of planets such as the Earth. GHGs absorb the wavelengths of radiation that a planet emits, resulting in the greenhouse effect. The Earth is warmed by sunlight, causing its surface to radiate heat, which is then mostly absorbed by greenhouse gases. Without greenhouse gases in the atmosphere, the average temperature of Earth's surface would be about −18° C. (0° F.), rather than the present average of 15° C. (59° F.).

The five most abundant greenhouse gases in Earth's atmosphere, listed in decreasing order of average global mole fraction, are: water vapor, carbon dioxide, methane, nitrous oxide, ozone. Other greenhouse gases of concern include chlorofluorocarbons (CFCs and HCFCs), hydrofluorocarbons (HFCs), perfluorocarbons, SF, and NF. As used herein CO2 refers to CO2 and equivalent greenhouse gases.

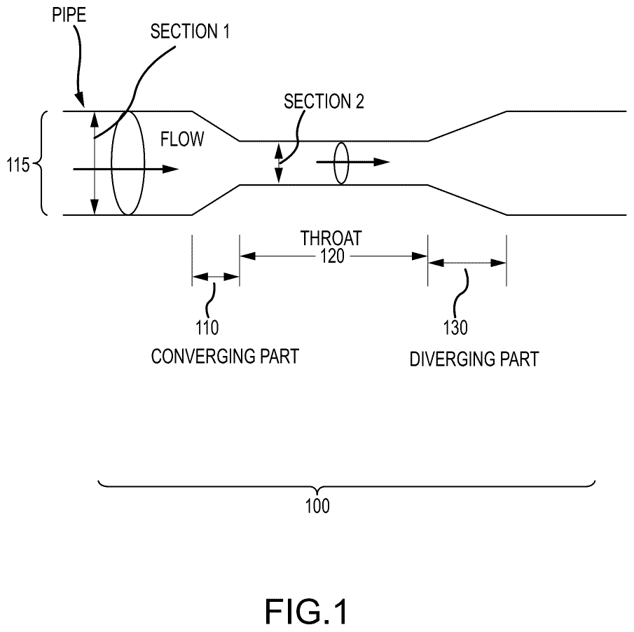

As used herein any reference to “venturi” means a device that uses the Venturi effect to increase the speed and decrease the pressure of a fluid. This effect is a result of Bernoulli's principle, which states that as the speed of a fluid increases, its pressure decreases. This effect takes place when an incompressible fluid passes through a narrow space and then a wider space. With reference to FIG. 1, a Venturi 100 is typically made up of a converging section 110, a throttle section 120 (also referred to herein as the neck or throat), and a diverging section 130. The converging section will narrow the space 115 and cause the fluid to increase its speed. The throttle section 120 is a small opening that sees the maximum degree of the pressure decrease (minimum pressure) of the fluid and maximum velocity. The diverging section 130 then widens the passage, allowing the fluid to slow down and correspondingly increase its pressure.

The Venturi effect is used in many applications, such as pumps, fuel injection systems, and air conditioning units as well as in medical devices, such as ventilators, to help regulate airflow and to deliver medications. The Venturi effect is also used in engineering applications, such as in vacuum pumps, to help increase the speed of the fluid and decrease its pressure, which helps to create a vacuum. Additionally, the Venturi effect can be found in wind turbines to increase the efficiency of the turbines by using the pressure differential to turn the blades.

There are different versions of a Venturi. The most common type is the standard Venturi device, which consists of a converging section, a throttle/throat section, and a diverging section as described above. However, there are also specialized versions of the Venturi device that are designed for specific applications. For example, the Venturi pump utilizes the Venturi effect to increase the speed of a fluid, while the Venturi injector is used in fuel injection systems to atomize fuel and air with its design focus being based on a desired pressure drop. Additionally, there are Venturi scrubbers, which use the Venturi effect to clean contaminated air.

As used herein any reference to “slurry” means a suspension of solid particles in a liquid medium, usually water. It is usually used in the industrial process of transporting materials and liquids in pipelines. When a slurry passes through a throttle or neck, it behaves differently than a normal liquid due to the presence of the solid particles. The particles cause the slurry to be more viscous, resulting in a higher pressure drop across the throat or neck. The particles can also cause plugging or clogging of the throat or neck, leading to a decrease in flow rate. Lastly, the particles can also cause turbulence or cavitation in the throat, neck, or diverging section leading to a decrease in pipe efficiency and reduced pressure. This cavitation and turbulent flow of a slurry are an important aspect of the present invention.

As used herein any reference to “cavitation” means the formation of vapor bubbles or cavities in a liquid resulting from a localized decrease in pressure. In a fluid flow, cavitation is produced by an increase in velocity, leading to a decrease in pressure relative to the liquid's vapor pressure. This decrease in pressure leads to the creation of vapor bubbles, which can then collapse due to the surrounding higher pressure. This sudden implosion of the bubbles causes intense shock waves that generate large increases in pressure and temperature. In venturi or similar linear flow restriction, cavitation occurs when the flow rate attained is sufficient to lower the local pressure to the saturated vapor pressure of the liquid within the throat of the device. While the cavitating zone in an orifice occurs typically at the edge of the throat section, the cavitating zone in a venturi instead expands toward the diverging section.

Cavitation converts the potential energy of a fluid into kinetic energy. As the fluid flows through a narrow section of the venturi the fluid's velocity increases dramatically. This rapid increase in velocity causes a decrease in pressure, which then causes cavitation. When the vapor bubbles collapse, the shock wave generates an impulse pressure. This impulse pressure transfers energy to the fluid and accelerates it further downstream. This energy transfer increases the kinetic energy of the fluid.

The energy transfer in cavitation described above can also act as a catalyst for a chemical reaction. Cavitation can create extreme temperatures and pressures, which can increase the rate of chemical reactions. The shock waves generated by the collapsing bubbles break down molecules, creating more reactive species. This increases the rate of reaction as well as provide more reactants for a reaction. Additionally, the turbulence created by the cavitation increases the mass transfer rate between two phases, allowing the chemical reaction to proceed more quickly.

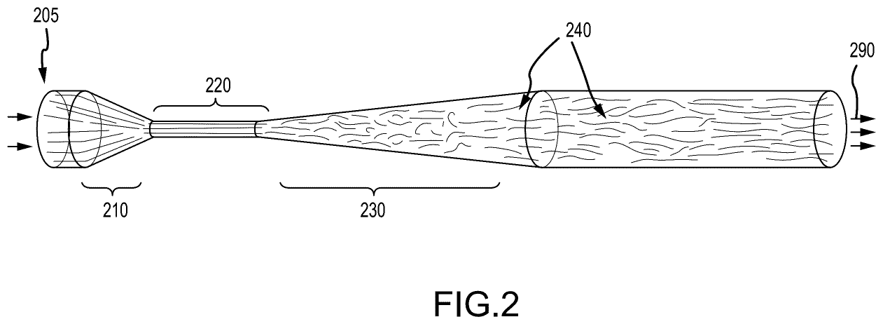

The process described above is chaotic. FIG. 2 is a graphical illustration of confined cavitated turbulent flow of an incompressible fluid. As the flow enters 205 the converging section 210 of the nozzle velocity of the flow rate increases. The flow rate reaches a maximum upon entering the throat 220. The pressure correspondingly decreases in accordance with Bernoulli's law reaching its maximum drop in the throat. As flow transitions through the divergent section 230 cavitation 240 occurs and the flow becomes turbulent/chaotic. Eventually the flow regains uniformity and laminar flow (nonturbulent flow) 290 is reestablished.

As used herein any reference to “precipitate” means a substance separated from a solution or suspension by chemical or physical change usually as an insoluble amorphous or crystalline solid. A precipitate is a product, result, or outcome of some process or action. In an aqueous solution, precipitation is the process of transforming a dissolved substance into an insoluble solid from a saturated solution. Temperature, pH, and ion concentration affect the precipitation of a substance.

The terminology used herein is for the purpose of describing embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to migrate gas which is captured in a slurry flow. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

### Venturi Based Mineralization

The slurry based, migrant gas capture system of the present invention engages a venturi, through which a saturated slurry flow traverses, triggers precipitation of a precipitate including, but not limited to, Calcium Carbonate(CaCO3) and Magnesium Carbonate (MgCO3). In one embodiment of the present invention the stimulation of cavitation and hydroxyl formation, brought on by a convergent/divergent nozzle (aka as a venturi) lowers the pH of the flow thereby triggering CaCO3/MgCO3 precipitation. Precipitation of CaCO3/MgCO3 occurs with a pH between 6.5 and 10.0 while in another embodiment, precipitation is initiated upon any pH decrease above pH neutral wherein the pH is as high as 12.3. (note: pH will increase through reversion potential when sulphates/sulfides are present such as H2S Feso4, FE11 etc. and/or certain hydrocarbon chains)

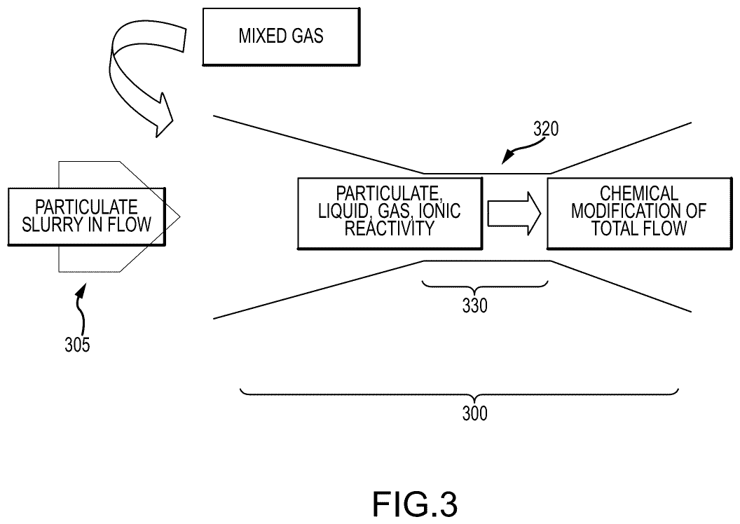

With reference to FIG. 3, the present invention directs a particulate slurry flow 305, an incompressible fluid, saturated with one or more detrimental elements such as Carbon through a venturi 300. In fluid dynamics, an incompressible fluid's velocity must increase as it passes through a constriction 320 in accord with the principle of mass continuity, while its static pressure must decrease 330 in accord with the principle of conservation of mechanical energy (Bernoulli's principle). Thus, any gain in kinetic energy a fluid may attain by its increased velocity through a constriction is balanced by a drop in pressure. As pressure drops below a fluid's vapor pressure the state of the substance changes from fluid to vapor. Bubbles are formed. And as pressure once again increases upon entrances into the venturi's divergent section, the bubbles collapse in a process called cavitation.

Another aspect of the flow of a fluid through the venturi is the flow characteristics. In fluid dynamics, turbulence or turbulent flow is fluid motion characterized by chaotic changes in pressure and flow velocity. This type of flow contrasts with a laminar flow, which occurs when a fluid flows in parallel layers, with no disruption between those layers. The smooth flow of air over a wing or airfoil, for example, is often envisioned as an example of laminar flow.

Laminar flow or streamline flow in pipes (or tubes) occurs when a fluid flows in parallel layers, with no disruption between the layers. At low velocities, the fluid tends to flow without lateral mixing, and adjacent layers slide past one another like playing cards. There are no crosscurrents perpendicular to the direction of flow, nor eddies or swirls of fluids. In laminar flow, the motion of the particles of the fluid is very orderly with all particles moving in straight lines parallel to the pipe walls. Any lateral mixing (mixing at right angles to the flow direction) occurs by the action of diffusion between layers of the liquid.

Turbulent flow is a flow regime characterized by chaotic property changes. This includes a rapid variation of pressure and flow velocity in space and time. In contrast to laminar flow, the fluid no longer travels in layers, and mixing across the tube is highly efficient. The onset of turbulence can be predicted by the dimensionless Reynolds number, the ratio of kinetic energy to viscous damping in a fluid flow. However, turbulence has long resisted detailed physical analysis, and the interactions within turbulence create a very complex phenomenon. Flows at Reynolds numbers larger than 4000 are typically (but not necessarily) turbulent, while those at low Reynolds numbers below 2300 usually remain laminar. Flow in the range of Reynolds numbers 2300 to 4000 are known as transition flows.

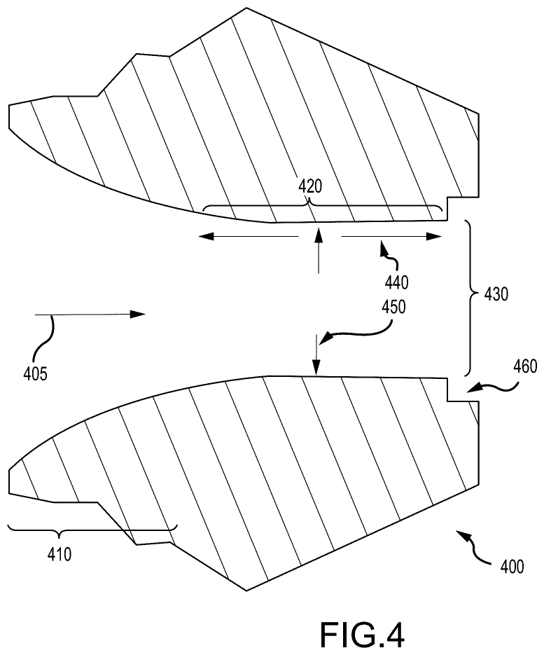

In one embodiment of the present invention a slurry flow 405 in which a contaminate, such as CO2, is saturated as a solute in the solvent, is directed through a convergent/divergent apparatus 400 such as a venturi shown in FIG. 4. As an example, CO2 or similar gas is effectively saturated into the water phase of the slurry as carbonic acid while the slurry conveys additional minerals such as Calcium Oxide and Clay (CaO/Silicates/Clay) as a solid in suspension.

The slurry, having certain solid particulates such as Calcium Oxide, Clay and the like, is joined with the saturated gas (CO2 and the like) in solution and pumped at a flow rate though a confined convergent/divergent apparatus 400 having a conical convergent section 410, a cylindrical throat 420, and a conical outlet 430. In this instance of the present invention the throat 420 shown in the cross-sectional depiction of FIG. 4, has a length 440 seven (7) or more times the diameter 450 of the throat. The convergent section 410 of the venturi is at least 3.5 times greater than the diameter 450 of the throat 420 and, in a preferred embodiment, five (5) times the throat's diameter 450. In both cases the convergent section presents a smooth transition.

The end of the throat includes a step 460. A step is a dramatic alteration in the structure of the venturi throat 420 section. In this embodiment of the present invention the diameter 450 of the throat 420 ends to form a discontinuity 460 to a larger diameter divergent section. The distinct transition in the diameter initiates a turbulent cavitated flow regime. Post the convergent section and/or throat an inlet introduces a gaseous component into the slurry flow. The added gas joins with the slurry acting as a catalyst once provided with adequate energy for one or more chemical reactions. In one instance atmospheric gases are added to the flow through a value or controlling mechanism creating the environment in which carbon dioxide in solution is joined with calcium or magnesium particulates to form CaCO3 or MgCO3, respectively, as a precipitate.

Recall that the slurry is an incompressible fluid; density of an incompressible fluid is a constant. And by virtue of Bernoulli's principal, as flow rate of an incompressible fluid in a confined area increases, the pressure decreases. The lower pressure alters the state of the saturated Carbon Dioxide to come out of solution as a gas and join with gasses and any added contaminates introduced in the flow. As the flow becomes turbulent at the step and in the mixing section, cavitation follows releasing substantial energy. The resulting environment (energy release) invokes a chemical reaction precipitating certain compounds including CaCO3 and MgCO3.

When utilizing differing metals of the electro-chemical series, the nozzle which forms the constraint to flow, yields ions to the motive fluid and the minerals contained in the slurry. The rapid reduction in velocity in the divergent section (shown hereafter) combined with the resulting cavitation generated from the turbulence and pressure drop imparts significant energy to reduce the covalent bonds associated with the motive fluid and that of the minerals in the slurry flow thereby changing the covalent nature of the ions in flow in a mechanism not dissimilar to galvanic activity on a volt cell. In a similar way ions within the motive fluid yield ions to the minerals and/or the aspirated gases, fluids, particulates, or minerals associated with the captured atmospheric/anthropogenic gases. These spontaneous oxidation or reduction reactions are increased by the pressure, pressure drops, velocity and cavitation when combined with an electrolyte in the motive fluids. An electrolyte in the form of mineral salts associated with the liquid portion of the slurry creates non-spontaneous redox activity like the electro-chemical mechanisms in a battery thus providing a chemical reaction within the combined slurry, migrant compounds and aqueous/non-aqueous fluid which provides the mechanism for additional precipitation of carbonates and ion exchange.

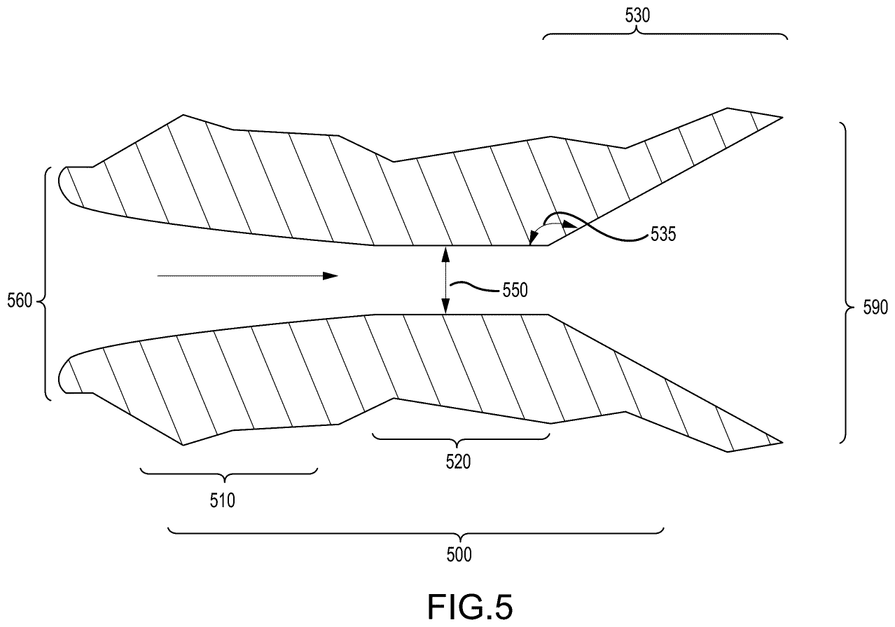

FIG. 5 presents one embodiment of the present invention of a mixing chamber 500 of a venturi for carbon capture and sequestration. As with the prior example, the chamber converges 510 to a second throat 520 followed by a divergent section. In this instance of the present invention the slurry flow, mixed with gasses having one or more containments or element(s) in solution such as CO2 passes through a mixing chamber 500 prior to being directed to a recovery tank.

The slurry is once again incompressible and by virtue of the constricting chamber, the flow velocity increases and static pressure decreases. The maximum decrease in pressure from an incoming pressure prior to the conical convergent section 510 for any flow rate occurs at the mixing chamber's cylindrical throat 520. In this instance the length of the convergent portion of the mixing chamber is based on the diameter of the mixing chamber's throat 550. Assuming this throat 520 possesses a diameter of T, the converging portion 510 of the venturi is configured, in this embodiment, to no more than 2T. Designating the entrance diameter of the venturi as E, the ratio of T to E is less than 1 and may vary based on the slurry composition and desired pressure drop. The transition from the entrance diameter of E 560 to the chamber's throat diameter 550 of T, occurring over the length of 2T is smooth and in one embodiment linear. In other embodiments the variance of convergence is non-linear to control and maintain turbulent (cavitated) flow through the throat.

The length of the throat can vary as well. In the example shown in FIG. 5 the throat 520 is equal or less than 1.5 T. The transition to the divergent section 530 in this embodiment is smooth and does not evoke a step as in the prior example. The diverging angle 535 is configured to maximize specific energy conversion and is shown in FIG. 5 as a linear ramp from the throat diameter T to the post flow diameter D 590. D must be sufficiently greater than T to diffuse the turbulent and cavitated flow transitioning it back to laminar flow. In one embodiment D is 1.3 T. In another embodiment D is 1.6 T. Other relationships between D and T are contemplated by the present invention and are a direct relationship to the slurry composition and desired precipitate.

In another embodiment of the present invention the diameter and configuration of the mixing chamber dynamically varies based on pressure and flow rate. While flow of the incoming slurry can be adjusted by the slurry feed pump, one embodiment of the present invention monitors the pressure and mixing within the mixing chamber and dynamically manipulates throat, and thereby the convergent section, diameter T to provide optimal energy conversion.

Prior to the mixing chamber an inlet 610 is positioned and configured to insert a gas through, in one embodiment, a value within the flow upon the pressure being at or below a predefined value. In one instance the valve is configured to introduce gas to the slurry flow at 0.2 or less of the input (entrance) pressure. In another embodiment the valve is configured to introduce gas at 0.8 of the vapor pressure of the slurry. In yet another embodiment the inlet is positioned in the conical divergent outlet yet at a point prior to the mixing chamber such that the relative pressure of the flow remains below that of the incoming pressure. The aspiration created by the pressure drop associated with the divergent and convergent components of the venturi generates a vacuum which is generalist in nature thereby motivating all substances within the zone of influence of the throat including gases, liquids, particulate matter, other slurry, or contaminants.

Within the converging portion and the cylindrical throat of the mixing chamber the local pressure of the slurry flow is less than the slurry's vapor pressure. Certain gasses come out of solution forming bubbles that, as the flow transients the chamber, coalesce. The presence of the bubbles and the step from the prior section transitions the flow through the mixing chamber from laminar flow to turbulent flow. And as the flow becomes chaotic, cavitation occurs collapsing the bubbles.

In the turbulent, chaotic flow, and in the presence of cavitation, a substantial amount of energy is released. This energy combined with the gas introduced though the inlet enhances the formation of new chemical compounds. Indeed, one such formation is of calcium carbonate (CaCO3). The formation of CaCO3 removes Carbon from the Slurry. That is, carbon introduced and sequestered into the slurry as CO2 is transformed in the slurry to CaCO3. CaCO3 precipitates within the flow and becomes a solid in suspension.

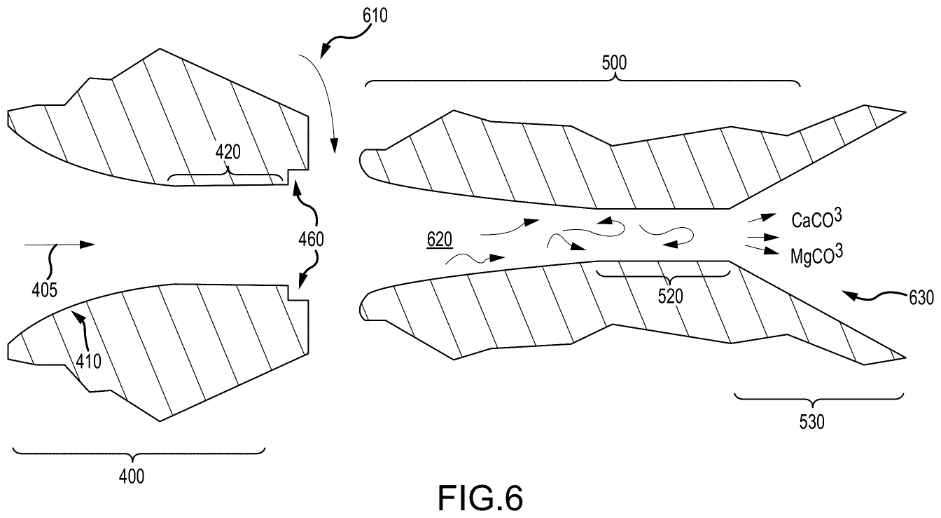

FIG. 6 shows a converging nozzle 400 in concert with a mixing chamber 500 for slurry-based migrant gas sequestration, according to one embodiment of the present invention. Slurry 405, delivered to the inlet of the converging nozzle 400 by a slurry feed pump, accelerates though the converging section 410 and the first throat 420 until it reaches a step 460 and a gap or inlet. The flow, now at a decreased pressure relative to the slurry inlet pressure, transitions from laminar to turbulent flow.

The lower pressure environment of the slurry flow exiting the convergent nozzle 400 provides a pressure differential by which gasses, including atmospheric gasses and the like, can be introduced 610 to the flow. In one embodiment, a valve (not shown) controls/manages the introduction of gas 610 to the slurry flow 405. Upon the flow reaching a predetermined pressure, the valve opens and gas(es) are introduced to the slurry.

Post exit from the nozzle the flow enters a mixing chamber 500. As a result of the step 460 the flow is turbulent 620 thereby mixing with the introduced gasses 610. The mixing chamber 500, as described herein, further converges the slurry path to a second throat 520. Pressure again drops driving certain gases out of solution forming bubbles. The bubbles collapse (cavitate) as pressure increases releasing energy. The energy release combined with the added gas as a catalyst creates an environment for the creation of CaCO3, MgCO3 630 and the like.

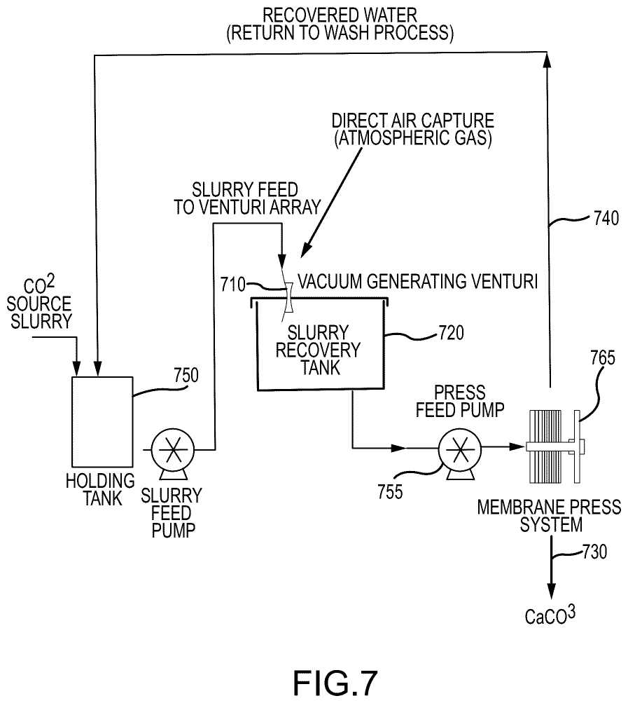

With reference to FIG. 7, in one embodiment of the present invention the flow downstream of a conical divergent outlet (venturi) 710 enters a slurry recovery tank 720 or similar holding/staging device where, thereafter, water is removed from the slurry leaving it rich with CaCO3 730. The captured water 740 or similar liquid is redirected to other processes to further capture carbon and other particulates or returned to a slurry holding tank 750. The dewatering of the slurry is accomplished by pumping it via a press feed pump 755 through a filter or membrane press 765 system described hereafter. The membrane, in this embodiment, is configured to remove precipitated CaCO3 760 and the like leaving an aqueous solution 740 for, in another embodiment, reintroduction to a CO2 sequestration circuit. Note, that the slurry does not always need to be dewatered. Should the converted substances aspirated into the throat be stable in the slurry, dewatering is not required and the slurry can be used until critical mass is reached.

The CaCO3 produce is thereafter collected and deposited at a storage site or used in other industries. For example, medicinally, CaCO3 is used as an antacid or as a calcium supplement. It is also used as filler in cosmetics and is added to swimming pools as a disinfectant agent and a pH corrector. CaCO3 also finds extensive usage in the manufacturing industry as a building material (marble), ingredient for quick lime and cement and it can also be used in agriculture.

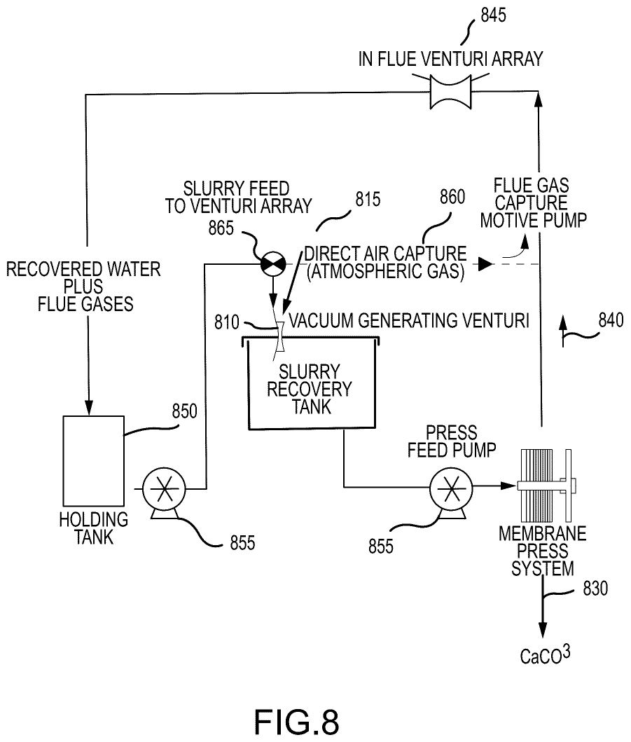

In another embodiment of the present invention illustrated in FIG. 8 the aqueous solution 840 because of the CaCO3 precipitate 830 being removed is returned to a flue 845, or similar carbon source such engine exhaust to again form a slurry of sequestered CO2. The slurry is staged in a holding tank and then directed to a venturi 810 or venturi array in which atmospheric or a designated gas 810 is introduced. As previously described the turbulence and cavitation induced by the venturi effect drives CaCO3 or other contaminates to precipitate out of the fluid restricting the slurry to contain CaCO3 in suspension. In another version of the invention the removal of CaCO3 is delayed. The slurry, with CaCO3, is returned 860 via a valve 865 to a source of CO2. CO2 is again sequestered in the slurry and returned to the staging or holding tank. As the slurry's percentage of solid matter increases, the valve 865 diverts the flow and the pumps drive the slurry through the venturi 810. The pumps 855 are adjusted to a flow rate to create a sufficient pressure drop, thereby inducing turbulence and cavitation, yet preventing a back pressure or clogging of the venturi due to the increase of solid matter.

Configuration of the venturi is relative to the required throughput. Throughput is driven by the displacement requirement (how much draw-down is required, i.e., in the case of a sand dryer using 35000 btu of air to drive the process one would calculate the velocity and the associated gases and create sufficient draw down to vacuum the gases (not all the air) into the venturi throat (mixer chamber inlet). In the case of exhaust emission from combustion one would calculate the total displacement to capture all gases and particulates.

The configuration of the convergent portion, the throat and the divergent mixing portion of the venturi is driven by the targeted vacuum generation (pressure decrease). The lower pressure invokes the introduction of gases into the flow. A portion of the gasses will mineralize joining with the carbon in the slurry to form, among other things CaCO3. Other gases will be involved redox, that is a reaction involving the transfer of electrons from one species to another. The species that loses electrons is said to be oxidized, while the species that gains electrons is said to be reduced. Others are encapsulated or converted to other gases. Each of these processed are based on the pH of the flow and ionic activity.

The present invention generates vigorous or extremely vigorous cavitation. In one embodiment the pressure/solid throughput ranges between 13-15 bar. Note, a bar is a unit of pressure, equal to 100,000 Pa. In another embodiment of the present the venturi/slurry flow is configured to provide a pressure/solid throughput equal or greater than 15.4 bar.

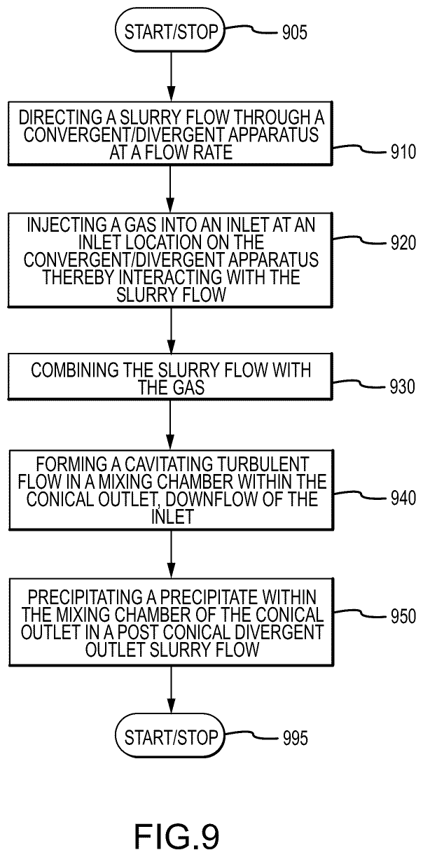

FIG. 9 presents a flowchart for one methodology for slurry based migrant gas sequestration, according to one embodiment of the present invention. As described herein the process begins 905, in one embodiment, by directing 910 a slurry flow through a nozzle of a convergent/divergent apparatus. As the flow passes through the converging section of the nozzle the rate increases. As the slurry is incompressible, the pressure drops in relation to the increase in velocity.

Upon reaching a desired pressure drop, by virtue of the convergent nozzle, the flow reaches a step function at the end of the throat of the nozzle inducing turbulent flow. Concurrently a gas (or gasses) is injected 920 into the flow thereafter interacting and mixing with the slurry. As the slurry and the gas combine 930 the turbulent flow enters a mixing chamber. The mixing chamber also includes a converging section and a mixing chamber throat. Within the mixing chamber the pressure within the flow decreases to the point that some of the gases within the slurry, as well as the gas injected into the slurry form bubbles. The bubbles coalesce and eventually collapse or cavitate 940. The cavitation releases energy, which, with the elements now present in the slurry, form one or more precipitates 950 ending 995 the process.

Another aspect of the present invention is to form a process by which carbon dioxide is removed from various industrial producing processes and sequestering the carbon in a storage CaCO3 state. In such a process a system conveys a slurry through a flue or similar carbon rich environment in which carbon is infused and saturated within the slurry. Similarly, the exhaust gas resident in the flue can be injected in the slurry through the inlet described herein. In that manner elements within the slurry react with the carbon in the turbulent environment of the mixing chamber causing the carbon to join with the oxygen and other elements including calcium and magnesium forming, in one example CaCO3 and/or MgCO3.

One version of the present invention presents a process and system by which a slurry containing CO2 in solution passes through a venturi at high velocity. As the slurry passes through the venturi, pressure within the venturi drops enabling the introduction of reactive gases to the slurry. Cavitation occurs when the pressure drops below the vapor pressure of the liquid, causing the formation of vapor bubbles. These bubbles collapse as pressure increases, releasing energy in the form of shock waves helping mix the slurry with the additive gases and increase a chemical reaction rate. In one version of the invention, atmospheric gas is introduced to a mixing chamber acting as a catalyst with ionic inversions. The gas creates a more uniform distribution of ions in the slurry, allowing for better reaction rates while reducing surface tension of the slurry, allowing for better mixing. The combination of cavitation, turbulent flow, and the addition of atmospheric gas creates an efficient reaction process forming a carbon rich precipitate such as CaCO3.

### Mineralization Environment

The creation of an environment for an efficient carbonate reaction process is a significant aspect of the present invention. As discussed herein, a venturi can be used to introduce energy to an optimized slurry flow forming a mineralization environment and thereby enabling a carbonate precipitate to form. In another embodiment of the present invention a mineralization environment can be created using a filter press or the like. Mineral types which are conducive to dewatering are ideal candidates for introduction to a filter press chamber to induce a mineralization environment, conversely those which are not can be changed using adjacent or dissimilar feed materials, chemical interactions, differing aqueous solutions, or changes in the filter cloth media design. Chemical modifications to a slurry flow can include but not limited to; polyacrylamide, coagulant, Na, NaCO3, Chlorides, acids, or alkaline solutions. Likewise, a gas can be injected/infused into the flow. Gases include the prime gases from the class of Noble gases, waste gas such as H2S, SOx, NOx, and Co2e, and mixed gases from prime or emissive sources. An oxidizing group can consist of CO2, CH4, N2O, NO2, Halogens, PFC, Sf6 NF3 and HFC as well as GHG's, Co2e. Carbon gases such as Hydrocarbons, Vapors forms thereof, Oxidizing and/or Reducing substances, and Particulates O2, O3, H2O2, F2, CL2, HNO3, KNO3, EO, KClO3 are also contemplated. The gas may also be selected from a reducing group consisting of Hydride, H-, K, Na, Ba, Mg i.e., NaH, LiH, LiAJH, CaH2, Ak and the like. The environment for mineralization is further fashioned by controlling the volume or amount of gas injected into the flow thereby controlling acidity of the gasified slurry flow.

Carbonate reactions involve the interaction of CO2 with various minerals, leading to the formation of carbonates. Several minerals can participate in these reactions, each resulting in different carbonate products. For example, Calcium Oxide (CaO) reacts with CO2 to form calcium carbonate (CaCO3), Calcium Hydroxide (Ca(OH)2) reacts with CO2 to produce CaCO3 and water, Magnesium Oxide (MgO) reacts with CO2 to form magnesium carbonate (MgCO3), Brucite (Mg(OH)2) can react with CO2 to form magnesite (MgCO3), Serpentine (Mg₃Si₂O₅(OH)4) forms magnesite upon reacting with CO2, with silica and water as additional products, Wustite (FeO) reacts with CO2 to form iron carbonate (siderite—FeCO3), Ferrous Hydroxide (Fe(OH)₂) forms siderite upon reacting with CO₂, Olivine (Mg,Fe)_₂SiO₄ contains both magnesium and iron and can thus help in forming mixed carbonates, Sodium Silicates (Na₂SiO3) can react with CO2 to form sodium carbonates and silica, and Alumina Silicates (e.g. Feldspars, (Na,K)AlSi₃O₈), under certain conditions, can react with CO₂ to form alumina, carbonates, and silica. Utilizing minerals for carbonation can mitigate industrial CO₂ emissions, turning waste materials into valuable byproducts.

Consistent with the present invention, the process of a chemical reaction between carbon dioxide and calcium oxide to form calcium carbonate is a classic example of a carbonation reaction and method for carbon sequestration. The mechanism for the reaction is Contact, Diffusion and Adsorption, followed by Reaction. First carbon dioxide gas encounters solid calcium oxide. CO2 molecules diffuse through the fluid and adsorb onto the surface of the CaO particles. The CO2 molecules react with the CaO molecules on the surface to form a solid layer of CaCO3.

The mineralization environment formed in the filter press relies on the feed pressure, press plate cavity size, the cloth/membrane used to dewater, closure pressure of the membrane, hold times and either an ambient or heated air-drying cycle from the core or the corner discharges as applicable. In one or more embodiments of the present invention the configuration of the filter press may include features such as:
cavity sizes ranging from 10 mm to 75 mm deep;
press plate size 300 mm×300 mm to 2400 mm×2400 mm;
multiple plates employed in the frames, no less than 5 plates (2×head/tail plate, 2×cavity and 1× membrane), e.g. 121 plates each with 2 head/tail plates, alternating with cavity/membrane;
press ram pressures (for holding the plates together during feed and squeeze portions of the process) to exceed the highest operational pressure;
feed pressure variance ±10 psi to 900 psi;
squeeze pressure to 2000 psi;
membrane/cloth is designed for particulate retention, water migration, air passage and chemical/ion resistance;
core blow heat ambient ±210° F.;
corner blow temperature ±210° F.; and
if stainless steel plates are utilized temperature can reach 500° F.

Temperature can significantly influence the rate and efficacy of this reaction. At lower temperatures (The reaction can be slow because the kinetic energy of the CO2 molecules is decreased, meaning less frequent and less energetic collisions between the reactant molecules. The reaction rate generally increases with temperature up to a certain point, an optimal temperature range, promoting faster chemical kinetics and higher diffusion rates of CO2 molecules. And after an optimal temperature range, the reaction rate may decrease if temperatures get too high. Decomposition of CaCO3 back into CaO and CO2 can occur at high temperatures (above approximately 840° C. for pure CaCO3.)

Pressure also affects the reaction when considering the availability and concentration of the reactant gas, such as CO2. At higher pressures, the solubility of carbon dioxide in the slurry (which typically consists of the metal oxide dispersed in water) increases. Greater solubility enhances the availability of molecules to react with the metal oxide. This higher concentration means more frequent collisions with the surface of the CaO, thereby potentially accelerating the reaction rate. Higher pressure promotes the forward reaction (formation of CaCO3), making it more efficient. Also, in an aqueous system under higher pressure, CO2 can form carbonic acid which subsequently dissociates into bicarbonate ions. The bicarbonate ions can further react with metal cations to form carbonate. At higher pressures, the formation of carbonic acid and subsequent bicarbonate ions is favored, promoting the reaction towards carbonate formation. The reaction between carbon-based gas and mineral oxide to form a carbonate is affected by both temperature and pressure. Moderate increases in temperature and pressure generally enhance the reaction rate by increasing molecular activity and collision frequency. High pressure makes the conversion of carbon dioxide and mineral oxide to carbonate more thermodynamically favorable.

In one embodiment of the present invention a mineral rich slurry flow is gasified providing it the components to create a precipitate. While in some instances some of the reactive components will join to form a precipitate such as CaCO3 or MgCO3 naturally, creating an environment by which conditions not only enhance the formation of the precipitate but drive it to a stable format is an objective of the present invention. In one embodiment of the present invention a gasified slurry flow is introduced to a filter press creating a mineralization environment.

A filter press plates typically comprises rectangular or square geometry with a center hole and four smaller holes at the corners. These holes are used in the processes for filling a cavity with the slurry and thereafter venting, vacuuming, purging or drying cycles. Typically, the center hole is used for filling and the corner holes are covered with filter media which allows for the aqueous liquid to pass as a filtrate. On occasions this process can be reversed where the filter media covers the center hole.

The plate/s contained within a filter press frame are sized for optimum dispersion of the mineralized slurry feed across the whole of the plate to create a full cavity with even pressure distribution. The width of the cavity within the press is designated by the feed materials (slurry) ability to compact within the cavity and become pressured by a feed pump. The pressure adds energy to the slurry enhancing a reaction between components thereby forming a precipitate. Upon formation of the precipitate associated liquid reactants such as H2O passes through the pores of a filter media leaving behind solids between the plates. Moreover, the pumping method can induce a turbulent flow within the press fostering more efficient and complete reactions.

In one embodiment of the present invention filter plates provide a pressure between 50-psi and 300-psi and temperature ranges between ambient temperature to 90 degrees Centigrade. In another embodiment of the present invention alternate filter plates increases the pressure range to 1500-psi and 500 degrees Centigrade inducing rapid formation of the precipitate.

In one version of the present invention, the filter presses are loaded when the press frame is closed and held under pressure. The hydraulic pressure rams hold the series of filter press plates together preventing materials from passing through the interface between the filter press plates and/or filter media. Loading is achieved by feeding the plates through one of the relevant feed ports from one end, both or in a cyclical nature. This type of loading supports even filling and distribution of the slurry throughout the cavity creating an even pressure distribution. As the plate cavities fill the feed pump reaches an operational pressure determined by the characterization of the mineral within the slurry. The pressurized mineralization environment triggers dissociation of the gas promoting formation of a mineral carbonate. For example, a slurry having CaO joins with CO2 to form CaCO3. During this process the aqueous part of the slurry being feed to the filter press starts to permeate through the filter media and the solids (CaCO3 and the like) are kept in the chamber, the recovered water is reused in the extraction process to motivate more slurry into the system for dewatering. In certain embodiments where Salts and Chlorides are present dissociative metals can be used to create a galvanic type of activity where electro-negativity is applicable for mineralization in the dewatering phase. While pump technology is well known, one aspect of the present invention is inducing electro-negativity. To achieve such results electro-negative materials within the pump system are selected to enhance rapid mineralization within the filter press chamber.

Typically, Filter press pressures do not exceed 300-psi in standard mineral dewatering due to limitations of pump design. Centrifugal and diaphragm pumps are selected along with displacement type pump units which can economically pump coarse solids to achieve the desired reactive pressures described herein.

The pressure cycle of the present invention begins with loading and filling of the filter press chamber. During loading and filling, the feed pump establishes a fill pressure. This fill pressure is selected for the relevant mineral, water constituent and rheology of the mineral along with the Co2e part. Typically, the feed pump gradually increases feed pressure as a state of fullness of the filter press chamber is achieved, this functionality is controlled by a Variable Frequency Drive unit coupled to a feed pressure transducer to automatically measure the feed pressure. Pressure is increased gradually to assist with even distribution of solids in the chamber and prevent drop out of the solids from the slurry during transfer to the chamber. A slow increase in pressure also reduces blockage or pockets of materials which impact the process flow. Pockets and/or blockages in the feed cycle can cause separation of Co2e components associated with the minerals being recovered and impact on the pressure state of the filter press chambers and thereby allow vapors to escape the capture system.

To assist in the reaction of minerals and constituent CO2e components alternative methods of pressure protocols are implemented to attain optimum pressure within the filter press chamber/s. These protocols include an impulse pressure of variable frequency as well as instilling turbulence and/or laminar feed changes controlled through a variable flow design or human interface. Each of these control features are programmed to adjust operation relevant to the chemical constituents and mineral component.

Temperature variances are expected due to the nature of the impoundment. Constant temperatures during a dewatering process are unusual and trends towards lower temperature as the material recovered is extracted from deeper levels of the deposit. Feed control temperature is used to average the temperature of the materials entering the filter press chamber. Additionally, temperature control of the dewatering phase is gained through the purging of the feed core and/or cycling hot or cooled air through the vent ports of the filter press plates. In the case of cooling the average temperature of the minerals with the chamber ambient, moisture cooled or refrigerated air can be used. Where ambient air is used, direct air is migrated through the units and associated Co2e can be transferred to the filter cake and added Co2e from the surrounding work environment can be captured simultaneously. Likewise, exhaust gases can be used to heat the fill to the best temperate for Co2e mineralization. Exhaust gases of this type can be entrained in the feed cycle or during the drying cycle.

One or more embodiments of the present invention sequester greenhouse gases including CO2 using a slurry flow and a filter press. A slurry flow is feed into a filter press assembly spreading into each press cavity from front to rear. In other versions of the present invention each cavity is occupied simultaneously. Greenhouse gases are entrained within the slurry flow by means of venturi, where employed, or injectors on the feed array, or by use of a catalyst. A slurry pump achieves target pressure within the filter press and the feed valve(s) close. This ensures the volume of each cavity is filled. Thereafter he feed core is cleared with compressed air returning any excess slurry to the feed tank. The squeeze cycle of the filter press is engaged. Upon reaching a predetermined squeeze pressure air blow commences either heated or ambient air through the core expanding across the filled cavity to the corner discharge vents, migrating the heat to the core. In other embodiments, additional greenhouse gases can be flowed through the press increasing the opportunity for absorptions/reaction. Following cycling of the pressure/heat the frame is opened for the cake (carbonate) to discharge via gravity or assisted by vibratory action.

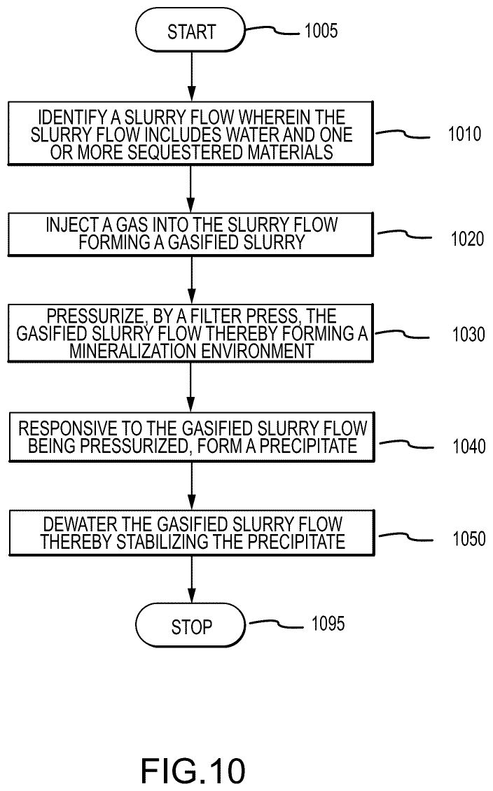

FIG. 10 presents one methodology, according to the present invention, for creating a mineralization environment to sequester greenhouse gasses. The process begins 1005 with identifying 1010 a slurry flow. The slurry flow includes, among other things, minerals, water, and other sequestered materials. In one version of the present invention, a gas is injected 1020 into the slurry flow forming a gasified slurry flow, with the gasified slurry flow thereafter being pressurized 1030 by a filter press. In other embodiments of the present invention the slurry flow is first introduced to filter press for pressurization and a gas injected concurrently or post pressurization. Responsive to the gasified slurry flow being pressurized and subjected to a mineralization environment, a precipitate is formed 1040. Lastly the slurry flow is dewatered 1050 stabilizing the precipitate and ending 1095 the process.

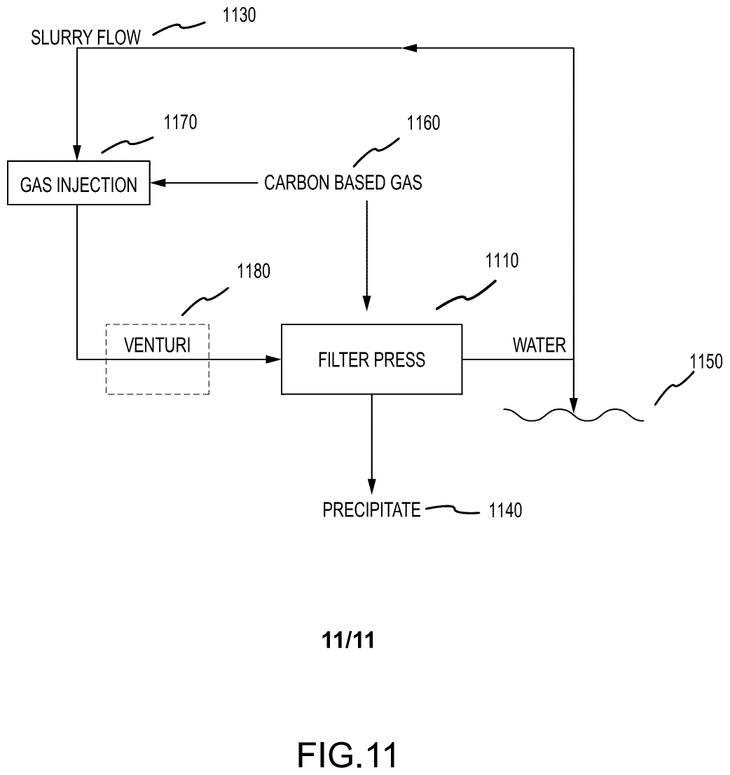

FIG. 11 provides a high-level depiction of a system for forming a mineralization environment for sequestering and mitigating greenhouse gasses. As shown, a slurry flow 1130 is directed to a filter press 1110. The filter press, by subjecting the slurry flow to increased pressure, temperature, ionization and/or the introduction of a catalyst forms a mineralization environment. A carbon-based gas 1160 is injected or infused into the slurry flow forming a gasified slurry flow either prior to entry to the filter press 1110 or within the filter press itself. Optionally, a venturi 1180 positioned prior to the filter press invokes a cavitation environment to enhance the mineralization process. As a result of forming a mineralization environment a carbonate precipitate 1140 is formed leaving water 1150 to be returned for additional use or recycled into a new slurry.

The present invention entrains greenhouse gases in the slurry flow. The amount of sequestration of greenhouse gases by the processes described herein can be measured by the water released from the slurry, which is recovered for reuse. The discharge cake quantifies the reduction/sequestration and conversion delta of greenhouse gases with incremental carbonate formation measured by analyzing the released dewatered slurry.

While there have been described above the principles of the present invention in conjunction with a slurry based migrant gas capture and sequestration system, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

What is claimed is:

1. A system for gaseous mitigation, the system comprising:
a slurry flow wherein the slurry flow includes water and one or more sequestered materials;
a gas injected into the slurry flow forming a gasified slurry flow;
a filter press configured to pressurize the gasified slurry flow thereby forming a mineralization environment; and
a precipitate formed within the mineralization environment and in response to the gasified slurry flow being pressurized.

2. The system for gaseous mitigation according to claim 1, wherein the gas is air.

3. The system for gaseous mitigation according to claim 1, wherein the precipitate is a carbonate.

4. The system for gaseous mitigation according to claim 3, wherein the precipitate is Calcium Carbonate (CaCO3).

5. The system for gaseous mitigation according to claim 3, wherein the precipitate is Magnesium Carbonate (MgCO3).

6. The system for gaseous mitigation according to claim 3, wherein the precipitate is Iron Carbonate (FeCO3).

7. The system for gaseous mitigation according to claim 3, wherein the precipitate is a crystalline carbonate.

8. The system for gaseous mitigation according to claim 3, wherein the precipitate is a crystalline, a polymorph or an amorphous.

9. The system for gaseous mitigation according to claim 1, wherein the gas is selected from the oxidizing group consisting of CO2, CH4, N2O, Halogens, PFC, Sf6 NF3, and HFC.

10. The system for gaseous mitigation according to claim 1, wherein the gas is selected from the reducing group consisting of Hydride, H-, K, Na, Ba, M, NaH, LiH, LiAIH, CaH2, and Ak.

11. The system for gaseous mitigation according to claim 1, further comprising a convergent/divergent apparatus and wherein the convergent/divergent apparatus includes an inlet.

12. The system for gaseous mitigation according to claim 11, further comprising a mixing chamber downflow of the inlet forming a cavitating turbulent flow.

13. The system for gaseous mitigation according to claim 1, wherein the one or more sequestered materials includes one or more oxide components.

14. The system for gaseous mitigation according to claim 13, wherein the one or more oxide components are selected from the group consisting of CaO, MgO, and FeO.

15. The system for gaseous mitigation according to claim 1, further comprising a stabilized precipitate formed in response to dewatering the precipitate.

16. A process for gaseous mitigation, the process comprising:
identifying a slurry flow wherein the slurry flow includes water and one or more sequestered materials;
injecting a gas into the slurry flow forming a gasified slurry flow;
pressurizing, by a filter press, the gasified slurry flow thereby forming a mineralization environment;
responsive to the gasified slurry flow being pressurized, forming a precipitate; and
dewatering the gasified slurry flow thereby stabilizing the precipitate.

17. The process for gaseous mitigation according to claim 16, wherein the gas is air.

18. The process for gaseous mitigation according to claim 16, wherein injecting includes controlling an amount of the gas injected thereby controlling alkalinity of the gasified slurry flow.

19. The process for gaseous mitigation according to claim 16, wherein the precipitate is a carbonate.

20. The process for gaseous mitigation according to claim 19, wherein the precipitate is Calcium Carbonate (CaCO3).

21. The process for gaseous mitigation according to claim 19, wherein the precipitate is Magnesium Carbonate (MgCO3).

22. The process for gaseous mitigation according to claim 19, wherein the precipitate is Iron Carbonate (FeCO3).

23. The process for gaseous mitigation according to claim 19, wherein the precipitate is dolomite (CaMgCO3).

24. The process for gaseous mitigation according to claim 19, wherein the precipitate is a crystalline carbonate.

25. The process for gaseous mitigation according to claim 16, wherein the filter press is a membrane filter press.

26. The process for gaseous mitigation according to claim 16, further comprising heating the gasified slurry flow thereby enhancing the mineralization environment.

27. The process for gaseous mitigation according to claim 16, wherein the gas is selected from the group consisting of CO2, CO4, N2O, and HFC.

28. The process for gaseous mitigation according to claim 16, wherein injecting includes directing a slurry flow through a convergent/divergent apparatus and wherein the convergent/divergent apparatus includes an inlet.

29. The process for gaseous mitigation according to claim 28, further comprising forming a cavitating turbulent flow in a mixing chamber downflow of the inlet, thereby combining the slurry flow with the gas.

30. The process for gaseous mitigation according to claim 16, further comprising inducing turbulent flow within the filter press.

31. The process for gaseous mitigation according to claim 16, further comprising controlling an amount of the gas injected thereby controlling acidity of the gasified slurry flow.

32. The process for gaseous mitigation according to claim 16, wherein the one or more sequestered materials includes one or more oxide components.

33. The process for gaseous mitigation according to claim 32, wherein the one or more oxide components are selected from the group consisting of CaO, MgO, and FeO.
